(19) United States
(12) Patent Application Publication
(10) Pub. No.: US 2020/0171504 A1
(43) Pub. Date: Jun. 4, 2020

(54) DEVICE FOR USE WITH A MULTICHANNEL PIPETTE

(71) Applicant: COASTAL GENOMICS INC., Burnaby (CA)

(72) Inventors: Jared Slobodan, Nanaimo (CA); Andrew Nobles, Vancouver (CA)

(21) Appl. No.: 16/640,601

(22) PCT Filed: Aug. 14, 2018
(86) PCT No.: PCT/CA2018/050981

§ 371 Date: Feb. 20, 2020

Related U.S. Application Data
(60) Provisional application No. 62/548,104, filed on Aug. 21, 2017.

(51) Int. Cl. B01L 9/00

(52) U.S. Cl. CPC B01L 9/54; B01L 2300/0858; B01L 2200/026; B01L 2300/041

(57) ABSTRACT

The present disclosure provides device for use with a pipette, the device comprising a body comprising one or more sample ports, each sample port comprising a cavity, a bottom, a registration feature comprising a tip landing zone and a guiding path for guiding a pipette tip from the tip landing zone to a tip target location. The invention also features a cassette for use in parallel electrophoretic assays, the cassette comprising a lid comprising the device. The present disclosure also provides methods for making same.

### CROSS REFERENCE TO PRIOR APPLICATIONS

This application claims priority under the Paris Convention to US provisional Patent Application Ser. No. 62/548,104, filed Aug. 21, 2017, which is incorporated herein by reference as if set forth in its entirety.

### FIELD OF THE DISCLOSURE

The present description relates generally to devices for use with a pipette. More particularly, the description relates to a device for use with multichannel pipettes.

### BACKGROUND OF THE DISCLOSURE

Multichannel pipettes present advantages over single channel pipettes in applications involving repetitive delivery of liquids. Multichannel pipettes may also be used with, for example, automated liquid handling workstations in applications involving repetitive, predictable pipetting operations. Automation of repetitive pipetting operations may facilitate higher throughput, lower operating costs, and/or, improved consistency in pipetting. However, laboratory protocols involving, for example, non-standardized lab ware, gelatinous media, and/or other non-standard pipetting target areas may not be well suited to automation, or even manual use of multichannel pipettes. In such cases, liquid handling by an individual practitioner using a single channel pipette may be advantageous relative to a multichannel pipette used either manual or with an automated machine, at least because an individual using a single channel pipette could see the target and make real time positional corrections to the position and direction movement of a pipette tip to ensure the pipette tip orifice is located in a desired position prior to aspiration and dispensing operations. For example, known liquid handling devices are not desirable for use in loading samples into one or more wells of an agarose gel, at least due to the small size of the wells and the low rigidity of the walls that define the agarose wells.

When pipette tips are loaded onto a manual pipette or onto mandrels of a liquid handling device, there is typically variation in “straightness” of the tips relative to their respective shaft or mandrel with which the tips are engaged (i.e., the longitudinal axis of the tip may not be in line with the intended longitudinal axis of the tip). Such axial deviation is known in the art as “tip splay”. Without positional feedback provided by a manual practitioner using a single channel pipette, the presence of tip splay means that the size of a desired sample delivery location that can be accurately targeted using a multichannel pipette, either manually by an individual user or with an automated system, is larger relative to the size of a well that can be accurately targeted using manual pipetting with a single channel pipette.

Off-target insertion of a pipette tip into a wall defining a sample delivery location may damage the underlying device into which the sample is being delivered, or may damage the pipette tip resulting in sample loss. Alternatively, if the sample delivery location is formed from a semi-solid material, (e.g., an agarose gel), off-target insertion of a pipette tip into the semi-solid material surrounding the sample delivery location may damage the semi-solid material and/or plug the pipette tip with semi-solid material, thereby interfering with subsequent aspiration or dispensing.

Tip splay in multichannel pipettes may also limit the throughput of certain applications, for example in gel electrophoresis applications where samples are delivered via a multichannel pipette to target locations aligned along a given axis. In existing products and devices, the maximum throughput is limited by tip splay, as the minimum possible spacing of sample delivery locations is limited to the width of possible tip splay in order to avoid inadvertent delivery of samples to adjacent sample delivery locations due to tip splay.

One mechanism to account for tip splay on a single channel pipetting head is to utilize a sensor that can provide feedback regarding the position of the tip. However, such a sensor would not be useful with a multichannel pipetting head comprising mandrels at fixed spacing, at least because the direction of tip splay may differ between tips, meaning that a single positional adjustment could not account for the splay in each tip.

There are examples of products and devices designed to address one or more of the above challenges associated with pipetting, for example with pipetting of samples into agarose gels. For example, U.S. Pat. No. 5,656,145 discloses a needle guide for use in loading samples in a vertical slab gel. The disclosed needle guide includes a rectangular port for receiving needles, with expanded upper openings that taper toward the sample wells, with the ports separated by partitions. This disclosure necessitates that the guide be positioned directly over the sample well, and further requires that the guide comprise a substantial thickness in order to accommodate the necessary taper through the rectangular port. The expanded upper opening, combined with the thickness of the guide, obscures the sample well. Further, the thickness of the needle guide disclosed in U.S. Pat. No. 5,656,145 as well as the needle guide's expanded upper opening obscure at least part of the electrophoretic laneway in a horizontal gel, preventing the efficient use of the entire electrophoretic laneway to resolve samples.

In another example, the EGel™ 96 agarose gel (Invitrogen) comprises 96 preformed wells in a staggered pattern and is designed for use with an automatic 96 channel liquid handling manifold. Rather than inserting sample-bearing pipette tips into the wells of the agarose gel, pipette tips are positioned above the wells of the EGel and dispensed. The dispensed sample is then drawn into a section of the well that is adjacent to the position of the tip by capillary action. Thus, the EGel would seem to overcome the issue of inserting the pipette tip into the gel, as the pipette tip remains above the upper surface of the gel. However, the positioning of the pipette tip above the upper surface of the gel may not be optimal, as operators may wish to insert the pipette tip into the cavity of the well, for instance to prevent bubble formation, to ensure the entirety of the sample volume is deposited into the well, and to minimize the opportunity for cross-well contamination which may be exacerbated when the pipette tip is dropped from a pipette tip above the surface of the gel. Further, each well of an EGel is relatively large, consisting of a shoulder zone and an adjacent compartment that draws dispersed fluid into the wells. The relatively large wells may address tip splay by providing a larger target for each pipette tip. However, the larger size of the wells in the EGel prevents maximization of the number of wells that can be positioned adjacent to one another in a gel, thereby limiting sample throughput.

It is an object of the present disclosure to mitigate and/or obviate one or more of the above deficiencies.

### SUMMARY OF THE DISCLOSURE

In an aspect, a device for use with a pipette is provided. The device comprises a body having an upper surface and a lower surface. The body comprises at least one sample port. The at least one sample port comprises: a) a cavity extending into the body from the upper surface toward the lower surface, but not traversing the body; b) a bottom defined by a floor plate; and c) a registration feature. The registration feature comprises: i) a tip landing zone; and ii) a guiding path for guiding a pipette tip along an axis from the tip landing zone to a tip target location. The at least one sample port is arranged on the body to receive a pipette tip held by at least one pipette. The axis along which the pipette tip travels when guided by the guiding path from the tip landing zone to the tip target location is substantially parallel to the plane of the upper surface of the body.

In an aspect, a device for use with a pipette is provided. The device comprises a body having an upper surface and a lower surface. The body comprises a plurality of sample ports. Each sample port comprises: a) a cavity extending into the body from the upper surface toward the lower surface, but not traversing the body; b) a bottom defined by a floor plate; and c) a registration feature. The registration feature comprises: i) a tip landing zone; and ii) a guiding path for guiding a pipette tip along an axis from the tip landing zone to a tip target location. The plurality of sample ports are arranged on the body to receive a pipette tip held by at least one multichannel pipette. The axis along which a pipette tip travels when guided by the guiding path from the tip landing zone to the tip target location is substantially parallel to the plane of the upper surface of the body.

In an embodiment of each device, the width of the tip landing zone is larger than the width of the tip target location.

In an embodiment of each device, the tip landing zone has a width larger than a width over which axial deviation of a pipette tip orifice from a pipette tip central axis does not exceed.

In an embodiment of each device, the guiding path comprises a contiguous gradient. In an embodiment, the gradient comprises a gradient slope made with respect to the axis along which a pipette tip travels when guided by the guiding path from the tip landing zone to the tip target location.

In an embodiment of each device, the registration feature is formed from material resistant to deformation under pressure imparted by a pipette tip coupled to the multichannel pipette.

In an embodiment of each device, the device further comprises, an aperture positioned at the tip target location, and traversing the body between the floor plate of the sample port and the lower surface of the body. In an embodiment, the aperture is configured to allow liquid from a pipette tip to be dispensed therethrough. In an embodiment, the aperture is configured to allow a pipette tip to be inserted at least partially therethrough.

In an embodiment of each device, the device is integrated into or adapted to engage with an apparatus for receiving pipetted liquid. In an embodiment, the apparatus comprises a plurality of receptacles for receiving the pipetted liquid. In an embodiment, the device is configured to overlay a gel medium, wherein the receptacles are wells positioned in the gel medium and spatially aligned with the aperture. In an embodiment, the device is configured as a lid to a cassette for use in an electrophoretic assay. In an embodiment, the lid is configured to overlay a gel medium contained within the cassette, wherein the receptacles are wells positioned in the matrix material and spatially aligned with the aperture.

In an embodiment of each device, the device further comprises a sample deposit site positioned at the tip target location. In an embodiment, the sample deposit site is positioned on a chip device, and the body is integrated into the chip device.

In an embodiment of the device comprising a plurality of sample ports, the plurality of sample ports are positioned in a row.

In an embodiment of the device comprising a plurality of sample ports, the plurality of sample ports are positioned in two or more offset parallel rows.

In an aspect, a cassette for use in parallel electrophoretic assays is provided. The cassette comprises: a) a tray having a floor and two pairs of opposing side walls extending upwardly from the floor, the tray at least partially defining a plurality of assay channels. Each of the assay channels comprises a media channel. The cassette also comprises: b) a lid adapted to engage the side walls of the tray, thereby creating a space between the tray floor and the lid. The lid comprises: i) an outer surface and an inner surface, and ii) a plurality of ports, each of the ports extending from an outer surface of the lid to an inner surface of the lid. The plurality of ports comprises: a plurality of sample ports for introducing a plurality of samples into the media channels, each of the plurality of sample ports comprising: a cavity extending into the lid from the outer surface toward the inner surface, but not traversing the lid, the bottom of the cavity defined by a floor plate; a registration feature, the registration feature comprising: 1) a tip landing zone; and 2) a guiding path for guiding a pipette tip from the tip landing zone to a tip target location in the respective sample port. The lid further comprises: iii) a plurality of apertures positioned at each respective tip target location and traversing the lid between the floor plate of the respective sample port and the inner surface of the lid.

In an embodiment of the cassette, the width of the tip landing zone is larger than the width of the tip target location in the sample port.

In an embodiment of the cassette, the tip landing zone has a width larger than a width over which axial deviation of a pipette tip orifice from a pipette tip central axis does not exceed.

In an embodiment of the cassette, the guiding path comprises a contiguous gradient. In an embodiment, the gradient comprises a gradient slope made with respect to the axis along which a pipette tip travels when guided by the guiding path from the tip landing zone to the tip target location.

In an embodiment of the cassette, the registration feature is formed from material resistant to deformation under pressure imparted by a pipette tip coupled to the multichannel pipette.

In an embodiment of the cassette, when the lid is engaged with the tray, the plurality of sample ports are aligned with the media channels. In an embodiment, the lid further comprises a plurality of sample extraction ports for extracting a plurality of samples from the media channel. In an embodiment, each of the plurality of sample extraction ports comprises an extraction registration feature for guiding a pipette tip to an extraction tip target location in the sample extraction port, the extraction registration feature comprising an extraction tip landing zone and an extraction guiding path for guiding a pipette tip to an extraction tip target location in the sample extraction port.

In an embodiment of the cassette, the lid further comprises a plurality of second sample ports, aligned with the plurality of media channels, spaced apart from the first plurality of sample ports along the length of the media channel.

In an embodiment of the cassette, the lid further comprises a plurality of media ports for introducing media into the media channels.

In an embodiment of the cassette, the cassette further comprises a gel medium, the gel medium being disposed in the media channels of the tray, the gel medium in each media channel comprising a well for receiving a sample, wherein when the lid is engaged with the tray, each well is aligned with the tip target location in one of the first plurality of sample ports.

In an embodiment of the cassette, the cassette further comprises a plurality of jersey walls extending from the lid into the space between the tray and the lid, at least partially providing a barrier between the media channels.

In an embodiment of the cassette, the tray further comprises a first buffer reservoir and a second buffer reservoir, the media channel extending between and in fluid communication with the first and second buffer reservoirs, and further wherein the lid further comprises a plurality of buffer reservoir ports for introducing and/or removing buffer, wherein when the lid is engaged with the tray, the plurality of buffer reservoir ports is in fluid communication with one or more of the first and second buffer reservoirs.

In an embodiment of the cassette, the cassette further comprises a buffer, the buffer being disposed in the first and second buffer reservoirs.

In an embodiment of the cassette, the plurality of ports further comprises a plurality of barrier ports for positioning at least a portion of first and second barriers into each of the assay channels, wherein when the lid is engaged with the tray, the plurality of barrier ports facilitate positing of the first and second barriers between the first buffer reservoir and the media channel, and the second buffer reservoir and the media channel, respectively.

### DESCRIPTION OF THE DRAWINGS

These and other features of the disclosure will become more apparent in the following detailed description in which reference is made to the appended drawings wherein:

FIG. 1 is a side elevation view of a pipette tip.

FIG. 2 is a top plan view of and embodiment of sample port and an aperture of a device for use with a multichannel pipette.

FIG. 3 is a top plan view of an embodiment of a plurality of sample ports and apertures of a device for use with a multichannel pipette.

FIG. 4 is a perspective view of an embodiment of a cassette comprising a cassette tray and a cassette lid, the lid comprising a device for use with a multichannel pipette.

FIG. 5 is a top plan view of an embodiment of a cassette comprising a cassette tray and a cassette lid, the lid comprising a device for use with a multichannel pipette.

FIG. 6 is a partial top plan view of an embodiment of a cassette comprising a cassette tray and a cassette lid, the lid comprising a device for use with a multichannel pipette and an enlarged presentation of a sample port and an aperture of the device.

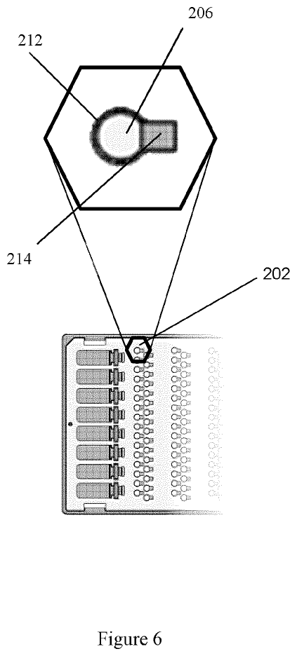

FIG. 7 is a side elevation in cross section, taken substantially along the line A-A of FIG. 4, when, for example, the cassette is translucent or transparent.

### DETAILED DESCRIPTION OF THE DISCLOSURE

Unless defined otherwise, all technical and scientific terms used herein have the same meaning as commonly understood by one of ordinary skill in the art to which this invention belongs.

The present disclosure is generally directed to a device for use with pipetting to locations with small surface area, specifically when doing so with single channel or multichannel pipettes, either operated manually or used with automated liquid handling systems.

Multichannel pipettes are configured to manipulate a plurality of fluid samples, automatically and concurrently, enabling high-throughput operations. Multichannel pipettes are marketed as being highly reliable and accurate. However, sometimes a multichannel pipette may malfunction during the liquid handling process or not perform to a user's expectations. For example, a sample may not be properly delivered to the desired sample location because one or more pipette tips may not be axially aligned to deliver the sample to a desired location with small surface area. Such a malfunction may lead to inaccurate or misleading results, or to no results at all.

### Device

As described herein, the inventors have provided a device for guiding the alignment of pipette tip orifices with small target locations of a fixed spacing. The device allows for the pipette tip to travel to the tip target location even when the tip exhibits tip splaying. The device is suitable for use in horizontal electrophoretic gels because it allow for efficient use of the entire electrophoretic laneway to resolve a sample electrophoresed through the laneway.

In an aspect, the device provided herein may be used with a pipette to guide a pipette tip to a tip target location (e.g., a location a user of the device desires the sample contained within the pipette tip to be delivered) relative to the device. The tip target location may be, for example, above a well for receiving a sample in a gel disposed in a cassette for use in parallel electrophoretic assays.

In an aspect, the device provided herein may be used with a pipette, for example, a multichannel pipette, to guide a plurality of pipette tips to a plurality of respective tip target locations (e.g., a location a user of the device desires the sample contained within the pipette tip to be delivered) relative to the device. The tip target locations are arranged to have a fixed distance between the centers of adjacent tip target locations, said fixed distance not exceeding the distance between the intended longitudinal axes of adjacent pipette tips. The tip target locations may be, for example, above a plurality of respective wells for receiving samples in a gel disposed in a cassette for use in parallel electrophoretic assays.

While various embodiments of the device are described below as they relate to a device having a plurality of sample ports for receiving a plurality of pipette tips and guiding each pipette tip to a tip target location within each respective sample port, the person skilled in the art will readily appreciate that such a device can be configured to have one or more than one sample port for receiving a pipette tips and guiding each pipette tip to a tip target location within the sample port.

In general, various embodiments of the device provided herein comprise a body with an upper surface, and a lower surface. The body has a thickness defined by the upper and lower surfaces. The body comprises a plurality of sample ports, for receiving a plurality of pipette tips and guiding each pipette tip to a tip target location within each respective sample port.

Each of the plurality of sample ports is formed by a cavity extending from the upper surface of the body toward the lower surface of the body, the cavity defining a top opening in the upper surface of the body. The cavity does not fully traverse the thickness of the body. The cavity has a bottom defined by a floor plate of the sample port. The floor plate is discussed further below. Each of the plurality of sample ports comprises a tip registration feature. The tip registration feature comprises a tip landing zone, where the pipette tip enters the sample port, and a guiding path for guiding a pipette tip from the tip landing zone to the tip target location in the sample port. In an embodiment the tip landing zone is formed by the floor plate.

In general, the tip landing zone is an enlarged portion of the cavity of a sample port, which accommodates initial aberrant pipette tip alignments (i.e., tip splay) such that no pipette tips entering the sample ports are damaged by accidental impingement on the upper surface of the body due to, for example, misalignment. Once partially disposed vertically (i.e., along a z-axis relative to the plane of the upper surface of the body) within the tip landing zone of the sample port cavity, the pipette tips can be moved laterally (i.e., in a plane substantially parallel to the plane of the upper surface of the body) to contact a tip guide rail, such as, for example, a portion of respective sample port orifice walls and be guided to the tip target location in the sample port (e.g., over an aperture extending through the body). As used herein, “substantially parallel” means that the movement of the guided pipette tip is in a plane such that when the movement of the pipette tip is guided, all portions of the path along which the pipette tip moves are equidistant from the upper surface of the body plus or minus 20%. Preferably path along which the pipette tip moves when guided is such that all portions of the path are equidistant from the upper surface of the body plus or minus 10%. More preferably, the path along which the pipette tip moves when guided is such that all portions of the path are equidistant from the upper surface of the body plus or minus 5%. Most preferably the path along which the pipette tip moves when guided is such that all portions of the path are equidistant from the upper surface of the body.

The tip registration feature also comprises a guiding path for guiding a pipette tip from the tip landing zone to the tip target location in the sample port. The guiding path extends from the tip landing zone to the tip target location. The perimeter of the tip registration feature is completely enclosed by a tip guide rail, which guides the lateral movement of a pipette tip with which it comes into contact. In one embodiment at least a portion of the tip guide rail is formed by the side walls of the cavity. The tip registration feature and the floor plate are each respectively formed of material resistant to deformation under pressure applied by a pipette tip being manipulated by a user or an automated liquid handling device. Rigid materials known in the art may be used to form the tip registration feature and the floor plate. Preferred materials include poly methyl methacrylate, polycarbonate (including, for example, non-autofluorescing polycarbonate), glass, or metal.

The tip target location is the portion of the sample port at which delivery of the sample contained within the pipette tip is desired. Preferably, the tip target location for the dispensing of the sample within the sample port will be disposed at the opposite end of the sample port from the tip landing zone.

The width of the tip landing zone is preferably large enough such that when a pipette mandrel is positioned directly over the center of the tip landing zone, the maximum possible deviation of the pipette tip orifice from the pipette mandrel that would permit proper operation of the pipette (e.g., aspiration of liquid or dispersion of liquid) is smaller than the perimeter of the tip landing zone. The shape of the tip landing zone may be any shape, provided that its perimeter is large enough to accommodate the maximum possible deviation of the pipette tip orifice from the pipette mandrel. In one embodiment, the tip landing zone has a generally spherical shape. In another embodiment, the tip landing zone has a generally square shape, with rounded corners and rounded sides.

The guiding path comprises a contiguous gradient which guides the pipette tip from the tip landing zone to the tip target location. The contour of the gradient may be formed by the thickness differential between the thickness of the body and the thickness between the floor plate and the lower surface of the body. In an embodiment, the gradient is formed by the sidewalls of the sample port. The gradient may comprise a slope, defined with respect to the axis formed by a central line passing through the center of the tip landing zone and the center of the tip target location, along the plane formed by the floor plate of the sample port. The slope of the gradient may be defined by the relative widths of the tip landing zone and the tip target location. The length of the guiding path may vary.

In one embodiment, the device further comprises an aperture positioned at the tip target location, and traversing the body between the floor plate of the sample port and the lower surface of the body. Such an aperture allows a sample contained in the pipette tip to be dispensed therethrough. In another embodiment, the tip target location comprises a cavity extending from the floor plate of the sample port towards the lower surface of the body.

In one embodiment, the tip target location may comprise an aperture extending through the floor plate and traversing the thickness of the body. Such an aperture may be configured to allow liquid from a pipette tip to be dispensed therethrough. Alternatively, such an aperture may be configured to allow a pipette tip to be inserted at least partially therethrough. In one embodiment, the device is adapted for use with an apparatus for receiving pipetted liquid. For example, the device may be integrated into or adapted to engage with an apparatus for receiving pipetted liquid, for example, a gel electrophoresis device or a multi-well device (for example a multi-well plate). The apparatus for receiving pipetted liquid may comprise a plurality of receptacles for receiving the pipetted liquid. The body of the device may be configured to overlay a multi-well device or a gel medium (i.e., to be positioned directly above, and either in direct contact or indirect contact with the multi-well plate or the gel medium). For example, when used with a gel medium, the body of the device may be in fluid communication with the gel medium (e.g., via an electrophoresis buffer). In an embodiment, the receptacles are wells positioned in the gel medium and spatially aligned with each aperture, such that the sample in the pipette tip positioned at a tip target location can be dispensed through the aperture and into the well. The well may be a well of a multi-well plate or may be a well positioned in the gel medium.

In various embodiments the device is for use with non-fixed (e.g., disposable) pipette tips. Such pipette tips may exhibit tip play more often and to a greater extend compared to pipette tips that are fixed with respect to the pipette.

In an embodiment, the device is integrated into or adapted to engage with a lid to a cassette for use in an electrophoretic assay. The cassette may comprise a cassette base and a cassette lid. The cassette base and cassette lid may be as described, for example, in WO 2015/106356, the entire teachings of which are incorporated herein by reference. In one embodiment, the lid, which the device is incorporated into is configured to overlay a gel medium contained within the cassette, wherein the receptacles are wells positioned in the gel medium and spatially aligned with each aperture, such that the sample in the pipette tip positioned at a tip target location can be dispensed through the aperture and into a well positioned in the gel medium.

In another embodiment, a sample deposit site may be positioned at the tip target location. The sample deposition site may be, for example, positioned on a chip device, such as a microfluidic chip, and the body is integrated into the chip device. The device disclosed herein enables the dispensing of fluid to small surface area wells despite the tip splay exhibited by non-fixed pipette tips.

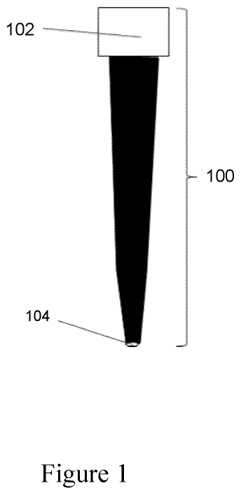

Referring to FIG. 1, which illustrates a disposable pipette tip 100, for use with the device provided herein, the pipette tip has a tip shoulder 102 and a tip orifice 104. The tip shoulder interfaces with the mandrel of a liquid handling pipette, for example, a multi-channel pipette which can be used to draw liquids into the tip 100 when the tip orifice 104 is submerged in a target liquid, such as a sample.

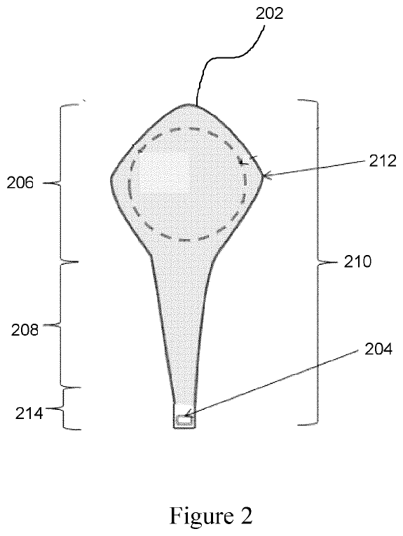

Referring to FIG. 2, which illustrates one embodiment of part of the device provided herein, the sample port of the device and the aperture of the device. In the embodiment shown in FIG. 2, a sample port 202, comprising a tip target location 204 is shown. The tip landing zone 206 is provided in the sample port 202, being located in a distal portion of the sample port 202, opposite the tip target location 204, with a guiding path 208 positioned between the tip landing zone 206 and the tip target location 204. The registration feature 210 in each sample port 202 is defined by walls 212 of the sample port 202, the walls thereby serving as a tip guide rail.

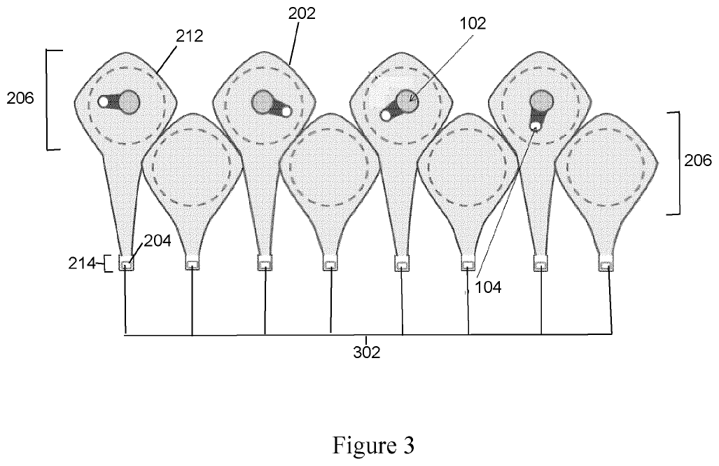

Referring to FIG. 3, which illustrates one embodiment of the positioning of a plurality of the ports and apertures of one embodiment of the device provided herein, various positions of the tip orifice 104 relative to the tip shoulder 102 are shown in some of the sample ports 202. These various positionings result in tip splay and the tip orifices 104, once entering the port are positioned in various positions throughout the tip landing zone 206 due to tip splay. The tip guide rail 214 narrows from the tip landing zone 206 through the guiding path 208. The sample ports 202 can be of varying lengths, such that all the apertures form a row. This positioning permits samples to be introduced into a greater number of receptacles 302 than would otherwise be possible if the number of receptacles 302 were limited by the maximum anticipated tip splay of a multichannel pipette.

### Use of the Device

Referring further to FIG. 3, in operation, a pipette tip comprising a liquid, such as a sample is lowered a pre-determined distance (i.e., along a z-axis relative to the plane of the upper surface of the body) by a multichannel pipette into the tip landing zone 206 of the sample port 202. The pipette tip is then moved laterally by the multichannel pipette along an axis (i.e., along a y-axis relative to the plane of the upper surface of the body). The tip guide rail 212 guides the tip toward the tip target location 204, which may be at an aperture 214, below which is positioned a receptacle 302, such as a well of an electrophoresis gel.

As a consequence of lateral movement of the pipette tip along this axis, the pipette tip may contact (i.e. register) a portion of the registration feature 210 such as the tip guide rail 212 (e.g., a wall of the sample port 202). Contact (i.e., registration) of the pipette tip with the guide rail 212 will occur if the axial deviation of the pipette tip orifice 104 from the mandrel engaging pipette tip shoulder 102 is larger than the width of the tip target location 204, that is, if the extent of tip splay of any individual pipette tip in a multichannel pipette exceeds the width of the tip target location 204.

The device of the present invention may be used in any application where accurate pipetting with a multichannel pipette is desired, for instance in a high throughput gel electrophoresis apparatus, a multi-well plate, or a microfluidic chip. In a preferred embodiment, the device of the present invention is used in a cassette for use in parallel gel electrophoretic assays, and more particularly with a cassette for use in automated parallel electrophoretic assays.

### Cassette

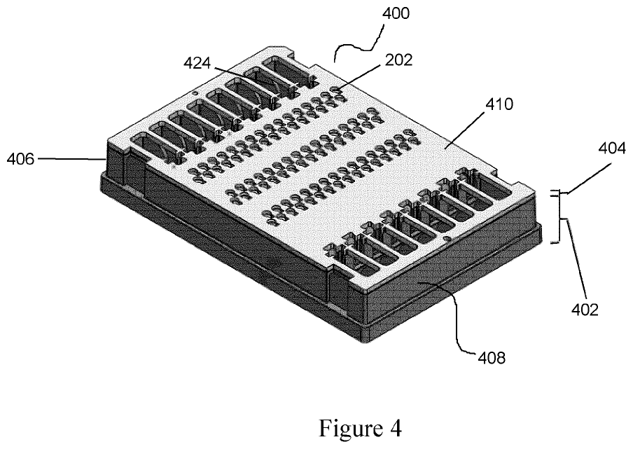

Referring to FIG. 4, which illustrates one embodiment of a cassette 400 with which the body of the device provided herein is adapted to engage, the cassette 400 comprises a tray 402 and a lid 404. The tray 402 has a floor and two pairs of opposing side walls 406, 408 extending upwards from the floor. The lid 404 has an outer surface 410 and an inner surface 412. The lid 404 is adapted to engage the side walls 406, 408 of the tray 402, thereby creating a space between the tray floor and the lid 404. For example, a lid 404 may be adapted to engage a tray 402 via mating parts (e.g. tongue and groove features), but such mating parts are not required. An electrophoresis gel and buffer may be disposed in the space between the tray floor and the lid, as described further below. The cassette 400 may be configured for communication with electrodes for use in one or more electrophoretic assays. In one embodiment, the outer surface 410 of the lid 404 is predominantly flat, permitting dense packing and storage of multiple lids and/or cassettes comprising a lid 404 and tray 402.

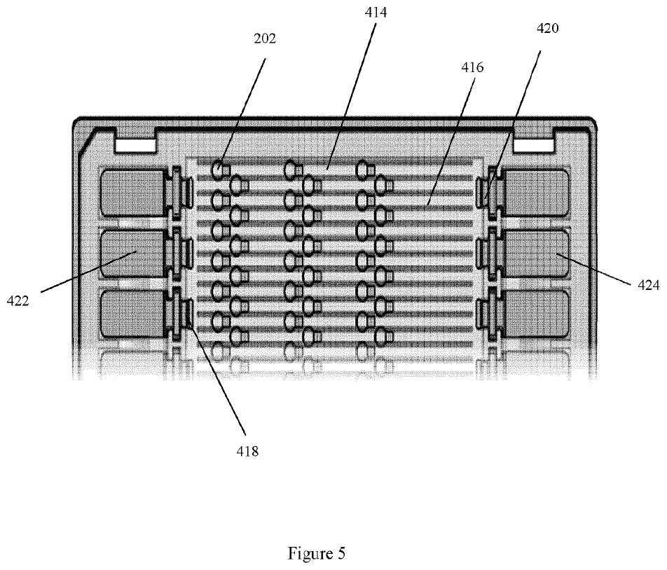

Referring to FIG. 5, which illustrates an embodiment of a partial view of a cassette 400, the tray 402 of the cassette 400 at least partially defines a plurality of assay channels. Each assay channel defines an electrophoretic laneway 414. The cassette 400 may contain various numbers of assay channels (e.g., 6, 12, 24, 48, 96 or more assay channels). In general, each assay channel in the cassette 400 comprises an elongated media channel separating, but in fluid communication with (during functional operation of the cassette), a pair of spaced apart buffer reservoirs (i.e. first and second buffer reservoirs), which are functionally identical unless otherwise indicated. While the tray 402 may define substantially all aspects of the assay channels, such arrangement is not considered to be necessary to the use or functionality of the various invention embodiments. In some embodiments, various features of the lid and tray together may together define the assay channels of the cassette 400.

Referring further to FIG. 5, in one embodiment, jersey walls 416 extending from the lid 404 into the space between the tray floor and the lid 404 are present. During functional operation of the cassette 400, the jersey walls 416 extend into the electrophoresis gel, partially defining and separating each electrophoretic laneway 414, thereby preventing cross contamination from one electrophoretic laneway 414 into a neighboring electrophoretic laneway 414 by means of capillary action at the interface of the electrophoresis gel and the lid 404. In one embodiment, the number of jersey walls 416 corresponds to the number of assay channels in the cassettes 400, such that every electrophoretic laneway 414 is bordered by a jersey wall 416 on each side.

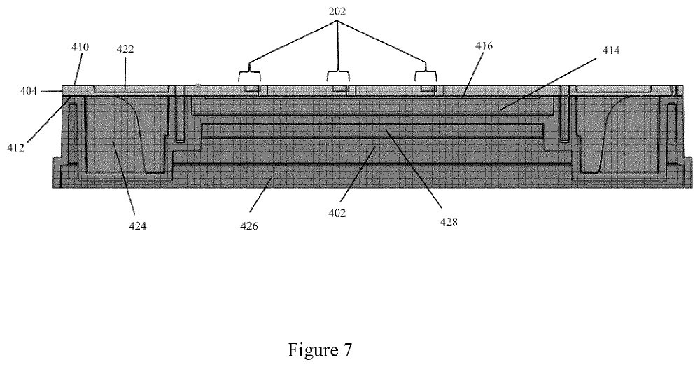

Referring to FIG. 7, the lid may comprise a plurality of ports, each of the ports extending from an outer surface of the lid 410 to an inner surface of the lid 412. The function of the plurality of the ports is to facilitate the introduction and/or removal of fluids, (e.g. media, buffer, samples) and/or electrical current.

In one embodiment, the cassette further comprises a gel medium, the gel medium being disposed in the media channels of the tray, the gel medium in each media channel comprising a well for receiving a sample, wherein, when the lid is engaged with the tray, each well is aligned with the tip target location in one of the plurality of sample ports. The gel medium may be, for example an electrophoretic matrix material, such agarose. In a preferred embodiment, the cassette further comprises a buffer, the buffer being disposed in the first and second buffer reservoirs.

Referring further to FIG. 5, in one embodiment, the plurality of ports comprises first and second buffer reservoir ports 418, 420 for introducing and/or removing buffer. When the lid 404 is engaged with the tray 402, the first and second buffer reservoir ports 418, 420 substantially align with first and second buffer reservoirs of a common assay channel in the tray, thereby permitting introduction or removal of buffer to the first and second buffer reservoirs of the assay channel via the first and second buffer reservoir ports 418, 420, respectively. In a preferred embodiment, the first and second buffer reservoir ports 418, 420 may also accommodate removable electrodes for use in electrophoretic operations. In such an embodiment, the lid 404 may comprise a plurality of electrode access ports 422. These electrode access ports may be divided to accommodate a plurality of reservoir baffles 424. The reservoir baffles 424 function to decrease lateral movement of liquid to mitigate spill hazards.

Referring further to FIG. 4, the plurality of ports further comprises sample ports 202 for introduction of a plurality of samples into each respective assay channel. In an embodiment, when the lid 404 is engaged with the tray 402, the sample ports 202 substantially align with a proximal end of the assay channel, and when the cassette 400 further comprises a gel medium such as an electrophoresis gel, the sample ports 202 substantially align with wells positioned in the gel for receiving a sample in the gel, thereby facilitating introduction of a sample into a well in a gel disposed in a media channel of the cassette. In one embodiment, the sample ports 202 are also used for introduction of media into the media channel of each assay channel.

In alternative embodiments, the sample ports 202 may be disposed on the device such that, when the device is in use, the sample ports 202 substantially align with the wells of a multiwell plate, or a reservoir in a microfluidics system.

Referring further to FIG. 5, in an embodiment the sample ports 202 are arranged in offset parallel rows, thereby permitting samples to be introduced into a greater number of assay channels than would otherwise be possible if the spacing between tip target locations, and therefore the number of assay channels, were limited by tip splay. The provision of sample ports 202 in offset parallel rows permits the spacing between tip target locations to be smaller than the maximum possible deviation of the pipette orifice from the pipette mandrel that would permit proper operation of the pipette.

In an embodiment, the plurality of ports in the cassette 400 further comprises a plurality of sample extraction ports, each of the plurality of sample extraction ports comprising an extraction tip landing zone, an extraction tip registration feature, and a tip target location. When the lid 404 is engaged with the tray 402, each of the sample extraction ports is substantially aligned with a distal end of an assay channel. The plurality of sample extraction ports may be provided in the lid 404 in the same orientation as the plurality of sample ports 202, or the plurality of sample extraction ports may be provided in an orientation rotated relative to the orientation of the plurality of sample ports 202. In an embodiment, the plurality of sample extraction ports are provided in the lid 404 in an orientation rotated 90 degrees relative to the orientation of the plurality of sample ports 202.

In an embodiment of the cassette 400, the plurality of ports further comprises ports referred to as barrier ports. Each assay channel comprises two barrier ports, a first barrier port being located between the first buffer reservoir port and the sample port, a second barrier port being located between the second buffer reservoir port and the sample extraction port. Each barrier port functions to receive a barrier that is used during the manufacture of the cassette to separate the first buffer reservoir from the media channel and the second buffer reservoir from the media channel, respectively. In the absence of a barrier, when the lid 404 is engaged with a tray 402, the first and second barrier ports substantially align with portions of the assay channel bridging a media channel and first and second buffer reservoirs respectively, thereby facilitating introduction of media to the media channel and optionally facilitating introduction of buffer to one or more of the buffer reservoirs. Barrier ports are not required in the cassettes disclosed herein, as media may be introduced into the media channel by way of, for example, sample ports and/or sample extraction ports, but may be provided in one or more preferred embodiments provided herein.

Referring further to FIG. 5, in an embodiment, the plurality of ports comprises a first plurality of sample ports 202, a second plurality of sample ports 202, and a third plurality of sample ports 202. When the lid is engaged with a tray, the first plurality of sample ports substantially aligns with a proximal end of a media channel in the tray 402, the second plurality of ports substantially align with approximately the midpoint of a media channel in the tray 402, and the third plurality of sample ports is positioned toward the distal end of the media channel. If the tray were to comprise an electrophoresis gel, and the lid were engaged with the tray, the first plurality of sample ports 202 would substantially align with a first plurality of wells for receiving a sample in the gel at the proximal end of each media channel, the second plurality of sample ports 202 would align with a second plurality of wells for receiving a sample in the gel at approximately the midpoint of each media channel, and the third plurality of sample ports 202 would align with a third plurality of wells for receiving a sample in the gel at approximately toward the distal end of each media channel. In this embodiment, each assay channel could accommodate three samples simultaneously, thereby tripling the sample capacity of the cassette 400. It will be apparent that although an embodiment with three pluralities of samples ports 202 is shown in FIG. 5, fewer than three (e.g., two) pluralities of sample ports 202, or more than three pluralities of sample ports 202 may be provided in a single cassette 400, permitting multiple samples to be resolved in a single assay channel simultaneously. The person skilled in the art will recognize to maximize the effective length of the assay channel over which each such sample is to be resolved, the spacing of the multiple pluralities of sample ports 202 should permit each sample to share an equal length of the media channel, that is, the multiple pluralities of sample ports should each be spaced apart equally over the entire length of the media channel.

Referring to FIG. 7, which illustrates an embodiment of the cassette 400, the tray 402 further comprises a skirt 426. The skirt 426 acts as a substrate for engagement of the tray 402 by grippers, for example, automated grippers for robotic handling of the cassette 400. In an embodiment, ribs 428, positioned on the underside of the tray 402 provide rigidity to the tray 402 and thus prevent deformation which can lead to the detachment of the gel from the underside of the lid 402.

### Manufacturing

The devices of the present invention may be manufactured in a number of ways known in the art, and with different materials known in the art. For example, manufacturing of a cassette embodying the present invention uses a transparent material that is easily formed, such as poly methyl methacrylate or polycarbonate, which are transparent and permit viewing of a sample deposited using the device. Further, poly methyl methacrylate and polycarbonate may be used in manufacturing processes that generate three dimension objects, for example injection molding or machining, which permit the formation of the sample ports. Other materials and manufacturing methods may also be used, including materials which do not deform under the pressure afforded by registration of the pipette tip. Examples of alternative manufacturing methods which can form three dimension structures include three dimensional printing, and laser cutting of multiple layers of material which are then merged to form a three dimensional structure.

Methods for manufacturing a cassette having a lid comprising the device as provided herein are generally known to the person skilled in the art. Methods includes those provided in WO 2015/106356, the entire contents of which are incorporated herein by reference.

For example, a method for manufacturing one or more embodiments of the cassette provided herein is disclosed. In one embodiment, the method comprises forming at least part of the tray and lid portions containing the device provided herein of the cassette from an optically neutral material, such as, for example, a clear thermoplastic, such as acrylic (e.g., poly methyl methacrylate) or polycarbonate. Methods of manufacturing articles from thermoplastics known in the art may be used to form at least part of tray and lid portions of the cassette, such as, for example, machining, injection molding, laser cutting or three dimensional printing. In one embodiment, the lid is manufactured of an optically neutral material, and is of sufficient thickness to permit imaging of the sample in the cavity below the lid without first requiring removal of the lid prior to imaging. In one embodiment, the thickness of the lid is minimized, thereby minimizing the amount of material required to manufacture the lid, for instance when manufactured using injection molding with thermoplastics known in the art.

In one embodiment, the method further comprises positioning a first removable barrier between the first buffer reservoir and the media channel in each of the assay channels of the formed tray and a second removable barrier between the second buffer reservoir and the media channel in each of the assay channels of the formed tray. In general, it is not necessary that the first and second removable barriers create a fluid impervious seal between the media channel and an adjacent buffer reservoir. Rather, it is only necessary that the removable barriers create a fluid barrier that substantially impedes cross migration of dissimilar fluids when there is not a material hydrostatic pressure differential across the barrier. When cross migration is no longer an issue due to, for example, a phase change in one of the fluids, the removable barriers are no longer needed and can be disabled, e.g., by removal of the removable barriers from the assay channels.

The barrier may have an elongated comb shape, each tooth in the barrier being sized and configured to engage the width and depth of an assay channel in the tray of a cassette. In a preferred embodiment, the number of teeth in a barrier corresponds to the number of assay channels in a cassette and the teeth are spaced along a longitudinal axis of the barrier such that they may be engaged in the assay channels of the cassette when the barrier is introduced into the cassette.

In one embodiment, a first removable barrier is positioned between the first buffer reservoir 1330 and the media channel in each of the assay channels and a second removable barrier is positioned between the second buffer reservoir and the media channel in each of the assay channels. In one embodiment, positioning of the first and second barriers may be done directly into a tray portion of a cassette. In a preferred embodiment, positioning of the first and second barriers may be done via barrier ports in a lid of a cassette. In a preferred embodiment, the barrier ports may comprise one or more structures for engaging at least part of one or more of the first and second removable barriers.

The method of manufacture further comprises introducing media into each media channel in the plurality of assay channels of the formed tray. In one embodiment, media may be introduced directly into the media channels of the formed tray. In one embodiment, media may be introduced via the sample ports when the device of the invention further comprises an aperture. In one embodiment, media may be introduced into the media channels via one or more sample extraction ports, and/or one or more portions of one or more barrier ports, wherein the one or more portion of one or more barrier ports is on a side of the first and/or second barrier, which abuts one or more media channels.

In one embodiment, the method further comprises positioning a comb into the introduced media in each media channel. In one embodiment, the comb has an elongated shape, each tooth in the comb being sized and configured to form a well in each media channel of a cassette upon gelification of the media. In a preferred embodiment, the number of teeth in a comb corresponds to the number of assay channels in a cassette and the teeth are spaced along a longitudinal axis of the comb such that they may be engaged in the assay channels of the cassette when the comb is introduced into the cassette. Positioning of the comb may be done at a location in the assay channels where gel wells are desired, and multiple combs may be used such that each assay channel contain more than 1 well. The person skilled in the art will recognize to maximize the effective length of the assay channel over which each such sample is to be resolved, the spacing of the multiple well should permit each sample to share an equal length of the media channel, that is, the multiple wells in each media channel should each be spaced apart equally over the entire length of the media channel. In a preferred embodiment, a sample extraction comb may be positioned in the assay channels comprising media at a position where sample extraction wells are desired.

In one embodiment, the method further comprises introducing buffer into each first and second buffer reservoir in each assay channel of the formed tray. In one embodiment, buffer may be introduced directly into the first and second buffer reservoirs of the formed tray. In one embodiment, buffer may be introduced into the first and second buffer reservoirs via one or more buffer reservoir port and/or one or more portion of one or more barrier ports, wherein the one or more portion of one or more barrier ports is on a side of the first and/or second barrier, which abuts one or more buffer reservoirs.

In one embodiment, the method further comprises removing the comb from the introduced media after gelification of the introduced media and removing the barrier after gelification of the media. In a preferred embodiment, the barrier is easily removable, at least because it is not configured to form a water-tight seal with the assay channels. In this embodiment, introduction of the media and buffer may be carried out substantially simultaneously without mixing of the media and buffer, at least because the partial pressures on either side of the barrier caused, at least in part, by the fluid on either side of the barrier are nearly equivalent and opposing in force, thereby inhibiting mixing of the media and buffer. Simultaneous media and buffer introduction may be advantageous, at least for example, because it may speed manufacturing time.

In one embodiment, the method further comprises engaging the formed lid on the side walls of the formed tray, thereby creating a space between the floor of the formed tray and the lid, the space being occupied at least partially by the introduced media and the introduced buffer. The step of engaging the lid on the tray may be completed prior to or following introduction of media and/or buffer and prior to or following positioning of barrier(s) and/or comb(s). In one preferred embodiment, lid and tray portions of the cassette may be integral. In this embodiment, the lid and tray portions would be engaged to form a cassette prior to introduction of media and buffer and prior to positioning of barrier(s) and comb(s).

In one embodiment, once lid and tray portions are formed, the method of manufacturing various embodiments of a cassette provided herein further comprises: establishing one or more temporary barriers between one or more buffer receiving portions of the cassette and a media receiving portion of the cassette; substantially simultaneously the filling buffer receiving portion(s) and the media receiving portion to minimize hydrostatic pressure differentials across the temporary barrier; and removing the temporary barrier once the hydrostatic pressure differential decreases below a threshold value. Such methods, as previously intimated, are preferably carried out simultaneously for multiple assay channels so that the benefits of parallel processing can be fully realized.

### Method of Using Cassette in an Electrophoresis Assay

In general, methods of using various embodiments of a cassette provided herein comprise generally directing a pipette tip to a sample port, for example by targeting a tip landing zone in the sample port provided in the lid; contacting the tip with a tip registration feature in the sample port; allowing the pipette tip to be guided along the tip registration feature to a tip target location in the sample port corresponding with a well in a gel disposed in the cassette therebelow; and dispensing the contents of the pipette tip. Such method is preferably carried out simultaneously in a plurality of assay channels in the cassette. In operation, a gantry arm of a suitable liquid handling device comprises an array of mandrels, each comprising a pipette tip. The gantry arm is moved such that each pipette tip is moved downward into a tip landing zone of each sample port and then laterally in the sample port until each pipette tip contacts a tip registration feature. The guiding path then guides the tip laterally toward the tip target location thereby ensuring uniform and consistent pipette transit into respective sample ports.

In one embodiment, the method comprises positioning the cassette in a liquid handling device. Liquid handling devices suitable for transferring liquids by pipette are known in the art. In this embodiment, one or more method steps are carried out by a liquid handling device. The method further comprises inserting a plurality of pipette tips into tip landing zones of the plurality of sample ports in a cassette. In a preferred embodiment, the plurality of pipette tips held by mandrels of the liquid handling device correspond to the plurality of sample ports and the relative spacing of the plurality of sample ports. The method further comprises moving the plurality of pipette tips inserted in the tip landing zones laterally toward the tip registration feature. The method further comprises registering the plurality of pipette tips against the one or more tip registration tip features, at least one of the one or more tip registration features per sample port being adjacent to the tip target location in each of the sample ports. Registration of the tips with corresponding registration features in a sample port ensures that the tips are in the tip target locations of each sample port, even if one or more tips on the liquid handling mandrel is splayed. The method further comprises dispensing a plurality of samples from the plurality of pipette tips positioned at the tip target location in each of the sample ports. This step facilitates introduction of a sample into a well in an assay channel without worry of inserting the tip into the media because the tip(s) is not positioned correctly.

In one embodiment, the method further comprises engaging the cassette comprising the plurality of dispensed samples with electrodes and a power supply, thereby creating one or more electric fields in the cassette, the one or more electric fields being sufficient to cause migration of the plurality of samples through the gelified media in the plurality of assay channels. Methods of electrophoretically treating samples (e.g., DNA, protein etc.) and tool for use of same are known in the art. In one embodiment, a single voltage may be applied to an entire cassette. In one embodiment, individual voltages may be applied to one or more assay channel in various embodiments of the cassette provided herein.

In a preferred embodiment, the method further comprises extraction of a migrated sample from the cassette, the cassette comprising a plurality of sample extraction ports. In this embodiment, the plurality of migrated samples is extracted from the cassette following exposure to the electric field. In one embodiment, the method of guiding pipette tips to the samples to be extracted is similar to the method of guiding pipette tips to the tip target location in the sample port for sample introduction. For example, in one embodiment, the extraction comprises: inserting a second plurality of pipette tips into extraction tip landing zones of the plurality of sample extraction ports in the cassette. The liquid handling device then moves the second plurality of pipette tips inserted in the extraction tip landing zones laterally toward the extraction tip registration features, until the second plurality of pipette tips are registered against the one or more extraction tip registration features, at least one of the one or more extraction tip registration features per sample extraction port being adjacent to an extraction tip target location in each of the sample extraction ports. As described above, this step adjusts for any tip splay in the second plurality of pipette tips. The method further comprises moving the registered second plurality of pipette tips downward into the gelified media below the second tip target location in each of the sample ports and aspirating the plurality of migrated samples from the gelified media below the extraction tip target location in each of the sample ports, thereby extracting the migrated samples. The plurality of pipette tips comprising the extracted, migrated samples are then retracting from the gelified media and the sample ports of the cassette.

Although the disclosure has been described with reference to certain specific embodiments, various modifications thereof will be apparent to those skilled in the art. Any examples provided herein are included solely for the purpose of illustrating the disclosure and are not intended to limit the disclosure in any way. Any drawings provided herein are solely for the purpose of illustrating various aspects of the disclosure and are not intended to be drawn to scale or to limit the disclosure in any way. The scope of the claims appended hereto should not be limited by the preferred embodiments set forth in the above description, but should be given the broadest interpretation consistent with the present specification as a whole. The disclosures of all prior art recited herein are incorporated herein by reference in their entirety.

1. A device for use with a pipette, the device comprising:
a body having an upper surface and a lower surface, the body comprising:
at least one sample port, each sample port comprising:
a cavity extending into the body from the upper surface toward the lower surface, but not traversing the body,
a bottom defined by a floor plate,
a registration feature, the registration feature comprising:
a tip landing zone; and
a guiding path for guiding a pipette tip along an axis from the tip landing zone to a tip target location,
wherein the at least one sample port is arranged on the body to receive a pipette tip held by at least one pipette, and further wherein the axis along which the pipette tip travels when guided by the guiding path from the tip landing zone to the tip target location is substantially parallel to the plane of the upper surface of the body.

2. A device for use with a pipette, the device comprising:
a body having an upper surface and a lower surface, the body comprising:
a plurality of sample ports, each of the plurality of sample ports comprising:
a cavity extending into the body from the upper surface toward the lower surface, but not traversing the body,
a bottom defined by a floor plate,
a registration feature, the registration feature comprising:
a tip landing zone; and
a guiding path for guiding a pipette tip from the tip landing zone to a tip target location,
wherein the plurality of sample ports is arranged on the body to receive a pipette tip held by at least one multichannel pipette, and further wherein the axis along which a pipette tip travels when guided by the guiding path from the tip landing zone to the tip target location is substantially parallel to the plane of the upper surface of the body.

3. The device of claim 1 wherein the width of the tip landing zone is larger than the width of the tip target location.

4. The device of claim 1, wherein the tip landing zone has a perimeter larger than a width over which axial deviation of a pipette tip orifice from a pipette tip central axis does not exceed.

5. The device of claim 1, wherein the guiding path comprises a contiguous gradient.

6. The device of claim 5, wherein the gradient comprises a gradient slope made with respect to the axis along which a pipette tip travels when guided by the guiding path from the tip landing zone to the tip target location.

7. The device of claim 1, wherein the registration feature is formed from material resistant to deformation under pressure imparted by a pipette tip coupled to the multichannel pipette.

8. The device of claim 1, further comprising an aperture positioned at the tip target location, and traversing the body between the floor plate of the sample port and the lower surface of the body.

9. The device of claim 8, wherein the aperture is configured to allow liquid from a pipette tip to be dispensed therethrough.

10. The device of claim 8, wherein the aperture is configured to allow a pipette tip to be inserted at least partially therethrough.

11. The device of claim 1, wherein the device is integrated into or adapted to engage with an apparatus for receiving pipetted liquid.

12. The device of claim 11 wherein the apparatus comprises a plurality of receptacles for receiving the pipetted liquid.

13. The device of claim 12, wherein the device is configured to overlay an electrophoretic matrix material, wherein the receptacles are wells positioned in the matrix material and spatially aligned with the aperture.

14. The device of claim 11, wherein the device is configured as a lid to a cassette for use in an electrophoretic assay.

15. The device of claim 14, wherein the lid is configured to overlay an electrophoretic matrix material contained within the cassette, wherein the receptacles are wells positioned in the matrix material and spatially aligned with the aperture.

16. (canceled)

17. (canceled)

18. The device of claim 2, wherein the plurality of sample ports are positioned in a row.

19. The device of claim 2, wherein the plurality of sample ports are positioned in two or more offset parallel rows.

20. A cassette for use in parallel electrophoretic assays, the cassette comprising:
a tray having a floor and two pairs of opposing side walls extending upwardly from the floor, the tray at least partially defining a plurality of assay channels, each of the assay channels comprising:
a media channel; the media channel extending between,
a lid adapted to engage the side walls of the tray, thereby creating a space between the tray floor and the lid, the lid comprising an outer surface and an inner surface, and a plurality of ports, each of the ports extending from an outer surface of the lid to an inner surface of the lid, the plurality of ports comprising:
a plurality of sample ports for introducing a plurality of samples into the media channels, each of the plurality of sample ports comprising:
a cavity extending into the lid from the outer surface toward the inner surface, but not traversing the lid, the bottom of the cavity defined by a floor plate;
a registration feature, the registration feature comprising:
a tip landing zone; and
a guiding path for guiding a pipette tip along an axis from the tip landing zone to a tip target location in the respective sample port,
the lid further comprising a plurality of apertures positioned at each respective tip target location and traversing the lid between the floor plate of the respective sample port and the inner surface of the lid,
wherein the axis along which a pipette tip travels when guided by the guiding path from the tip landing zone to the tip target location is substantially parallel to the plane of the outer surface of the lid.

21. The cassette of claim 20, wherein:
the width of the tip landing zone is larger than the width of the tip target location in the sample port;
the tip landing zone has a width larger than a maximum deviation of a pipette tip orifice from a pipette tip central axis;
the guiding path comprises a contiguous gradient, the gradient comprising a gradient slope made with respect to the axis along which a pipette tip travels when guided by the guiding path from the tip landing zone to the tip target location in the respective sample port, or
wherein when the lid is engaged with the tray, the first plurality of sample ports are aligned with one of the media channels.

22. The cassette of claim 20, further comprising a plurality of jersey walls extending from the lid into the space between the tray and the lid, at least partially providing a barrier between the media channels.
